(19) United States
(12) Patent Application Publication
(10) Pub. No.: US 2008/0183449 A1
(43) Pub. Date: Jul. 31, 2008

(54) Machine parameter tuning method and system

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/700,094

(22) Filed: Jan. 31, 2007

(51) Int. Cl. G06G 7/70

(52) U.S. Cl. 703/8

(57) ABSTRACT

A method for setting up setup parameters for a machine to perform a time-constraint task over a fixed course. The method may include establishing a process model indicative of interrelationships between performance parameters of the machine and a plurality of setup parameters of the machine based on data records generated by a computer system. The performance parameters may be associated with constraint parameters of the machine and the setup parameters are associated with condition parameters of the fixed course. The method may also include obtaining values of the condition parameters; adjusting the process model to generate a desired set of values of the setup parameters corresponding to a desired set of values of the performance parameters of the race car based on the values of condition parameters; and presenting the desired set of values setup parameters.

### TECHNICAL FIELD

This disclosure relates generally to computer based process modeling techniques and, more particularly, to methods and systems for tuning race car parameters using process models.

### BACKGROUND

Sports races with various race vehicles have been known and popular for centuries. Their popularity has often led to the development and use of special vehicles for the type of race, race track improvements, and driving techniques, etc. In the automotive racing field, new technologies have made the race vehicles reach speeds close to physical limits. At such high speed, any factors of the race vehicles, in addition to their engines, may be considered as critical, such as shapes and weights of the race vehicles, and race track condition parameters, such as wind and temperatures, etc. However, it is often technically difficult and/or financially impractical to determine the impact of such factors and to adjust race vehicles according to these factors.

Computer simulation technologies have been developed to simulate physical race vehicles under various racing conditions with certain operational parameters. For example, U.S. Patent Application Publication No. 2004/0135677 published on Jul. 15, 2004, to Asam discloses computer-based simulation race car games using data obtained from positioning systems for racing cars. The type of data may reflect physical conditions of the race cars, such as real-time axis of the racing course, or the real driving condition data and operating data, etc., and are entered as marginal conditions for the simulation games. However, such conventional simulation techniques do not address factors of the environment outside of the race cars or the relationships between these operational factors and the racing performance. Further, such techniques do not provide means to optimize values of race car setup parameters based on the relationships.

Methods and systems consistent with certain features of the disclosed systems are directed to solving one or more of the problems set forth above.

### SUMMARY OF THE INVENTION

One aspect of the present disclosure includes a method for setting up setup parameters for a machine to perform a time-constraint task over a fixed course. The method may include establishing a process model indicative of interrelationships between performance parameters of the machine and a plurality of setup parameters of the machine based on data records generated by a computer system. The performance parameters may be associated with constraint parameters of the machine and the setup parameters are associated with condition parameters of the fixed course. The method may also include obtaining values of the condition parameters; adjusting the process model to generate a desired set of values of the setup parameters corresponding to a desired set of values of the performance parameters of the race car based on the values of condition parameters; and presenting the desired set of values setup parameters.

Another aspect of the present disclosure includes a method for setting up setup parameters for a machine to perform a time-constraint task over a fixed course. The method may include starting a process model indicative of interrelationships between performance parameters of the machine and a plurality of setup parameters of the machine based on data records generated by a computer system. The performance parameters are associated with constraint parameters of the machine and the setup parameters are associated with condition parameters of the fixed course. The method may also include obtaining values of the condition parameters and the setup parameters, which may include hard setup parameters and soft setup parameters. Further, the method may include generating values of the performance parameters and the constraint parameters based on the process model and the values of the condition parameters and the setup parameters; determining desired values of the setup parameters corresponding to desired values of the performance parameters with permissive values of the constraint parameters; and presenting the desired set of values setup parameters.

Another aspect of the present disclosure includes a computer system. The computer system may include a database and a processor. The database may contain data records associating a plurality of setup parameters and a plurality of performance parameters corresponding to a machine performing a time-constraint task on a fixed course. The processor configured to establish a process model indicative of interrelationships between performance parameters of the machine and a plurality of setup parameters of the machine based on data records generated by a computer system. The performance parameters may be associated with constraint parameters of the machine and the setup parameters are associated with condition parameters of the fixed course. The processor may be further configured to obtain values of the condition parameters; to adjust the process model to generate a desired set of values of the setup parameters corresponding to a desired set of values of the performance parameters of the race car based on the values of condition parameters; and to present the desired set of values setup parameters.

### BRIEF DESCRIPTION OF THE DRAWINGS

FIG. 1 illustrates a block diagram of an exemplary racing parameter tuning and modeling environment consistent with certain disclosed embodiments;

FIG. 2 illustrates a block diagram of a computer system consistent with certain disclosed embodiments;

FIG. 3 illustrates an exemplary model generation and optimization process consistent with certain disclosed embodiments;

FIG. 4 illustrates an exemplary data generation process consistent with certain disclosed embodiments; and

FIG. 5 illustrates an exemplary model operation process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

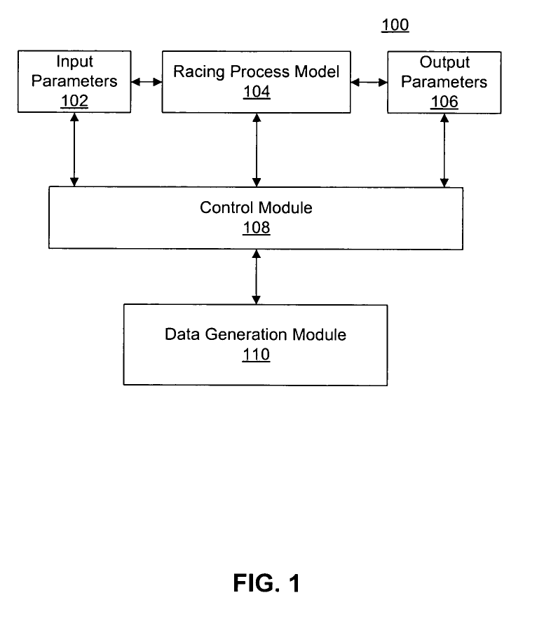

FIG. 1 illustrates a flowchart diagram of an exemplary racing parameter tuning and modeling environment 100. As shown in FIG. 1, racing parameter tuning and modeling environment 100 include input parameters 102, a racing process model 104, output parameters 106, a control module 108, and a data generation module 110. It is understood that the above components are listed for illustrative purposes, and that other components may also be included.

Input parameters 102 may include any appropriate type of data associated with a racing application. For example, input parameters 102 may include racing records from different race cars and race tracks, and from different race simulations performed by computer systems. Output parameters 106, on the other hand, may correspond to certain racing results of the race cars, such as lap time, etc., or any other types of output parameters used by the particular racing application.

Racing process model 104 may be established to build interrelationships between input parameters 102 and output parameters 106 under the control of control module 108. Control module 108 may use data generation module 110 to generate data records for racing process model 104, including values for input parameters 102 and output parameters 106. After racing process model 104 is established, values of input parameters 102 may be provided to racing process model 104 to predict values of output parameters 106 based on the given values of input parameters 102 and the interrelationships between input parameters 102 and output parameters 106.

Racing process model 104 may include any appropriate type of mathematical or physical model indicating interrelationships between input parameters 102 and output parameters 106. For example, racing process model 104 may be a neural network based mathematical model that is trained to capture interrelationships between input parameters 102 and output parameters 106. Other types of mathematic models, such as fuzzy logic models, linear system models, and/or non-linear system models, etc., may also be used.

Racing process model 104 may be trained and validated using data records collected from a particular application for which racing process model 104 is established. That is, racing process model 104 may be established according to particular rules corresponding to a particular type of model using the data records, and the interrelationships of racing process model 104 may be verified by using part of the data records. After racing process model 104 is trained and validated, racing process model 104 may be optimized to define a desired input space of input parameters 102 and/or a desired distribution of output parameters 106. The validated or optimized racing process model 104 may used to produce corresponding values of output parameters 106 when provided with a set of values of input parameters 102.

Data generation module 110 may provide data records used by racing process model 104. Data generation module 110 may include any appropriate type of data source providing data records for establishing and operating racing process model 104. For example, data generation module 110 may include a race car simulation computer program. Data generation module 110 may allow a user to select a race track among different race tracks, and to select and/or configure a race car from a list of configurable race cars. The race car may be represented by a certain number of parameters describing the race car in the computer program. The user may start a race with the selected race car on the selected race track by running the simulation program.

Further, when including the race car simulation computer program, data generation module 110 may be provided based on a physical or mathematical simulation model of specific race cars. The simulation model of data generation module 110 may include a variety of parameters of the specific race cars, some may be changeable, such as setup parameters of the race car, and some may be unchangeable, such as environmental or condition variables of the race car or the race track. Driver characteristics related to man-machine interfaces may also be recorded, such as steering rate and acceleration, brake application rate and acceleration, or a statistical description of a path around the track. Further, data generation module 110 may obtain values for the changeable parameters from a user or control module 108, and may set default values for the unchangeable parameters or for changeable parameters that are not set to specific values by the user or control module 108. Further, data generation module 110 may provide simulated racing results, such as lap time, and/or physical conditions of the race car after the race.

Data generation module 110 may also include certain computer programs that allow the user to input data records collected from physical race cars performing actual races or race exercises. For example, data generation module 110 may obtain characteristic data and setup parameters from an individual race car and any other recorded parameters, such as ambient temperature, etc. Data generation module 110 may process the collected data and provide the processed data records to control module 108 and/or racing process model 104. As used herein, the term “race car” is intended broadly to include any type of vehicle used in racing, such as motorcycles, trucks, boats, or aircraft. Thus, the term “race car” is synonymous with “race vehicle.” Further, race car may also include other machines that perform tasks under time constraints, where racing may be referred to as a desired completion of the time-constrained task, such as in shortest time period, etc. For example, an earthmoving machine may be provided to move a maximum amount of earth in a shortest time period a spatially-constrained work site.

Control module 108 may provide control and/or coordinating functionalities to facilitate interactions among the various components. For example, control module 108 may provide data generated by data generation module 110 to racing process model 104 and may also process the generated data to be included in input parameters 102. Control module 108 may include any appropriate type of computer program designed to provide the control and/or coordinating functionalities. Although FIG. 1 show an environment for a race car with respect to a race, the environment may be used for any machine with respect to any time-constrained task performed by the machine.

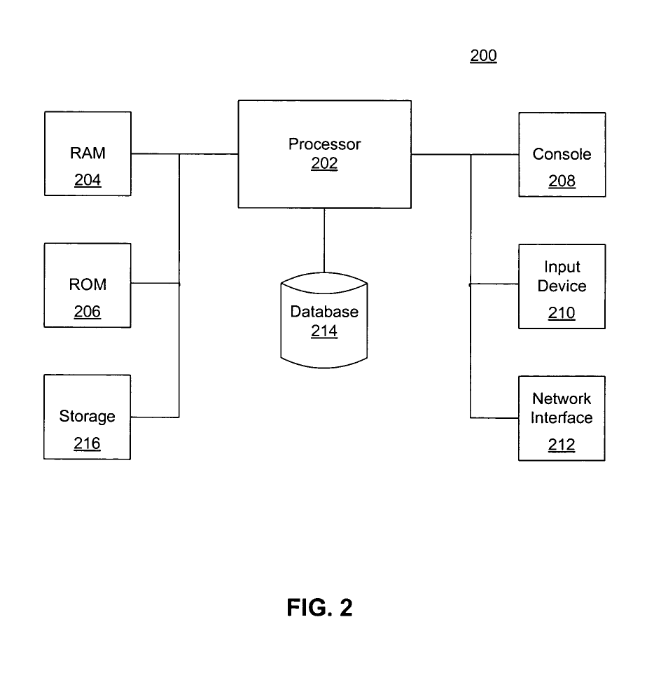

The establishment and operations of racing process model 104 may be carried out by one or more computer systems. FIG. 2 shows a functional block diagram of an exemplary computer system 200 that may be used to perform these modeling processes and operations. As shown in FIG. 2, computer system 200 may include a processor 202, a random access memory (RAM) 204, a read-only memory (ROM) 206, a console 208, an input device 210, a network interface 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. Processor 202 may be coupled to or access other devices, such as RAM 204, ROM 206, console 208, input device 210, network interface 212, database 214, and/or storage 216, to complete executions of computer program instructions. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more floppy disk device, hard disk device, optical disk device, memory disk device, or other storage devices to provide storage space.

Console 208 may provide a graphic user interface (GUI) to display information to a user or users of computer system 200. Console 208 may include any appropriate type of computer display device or computer monitor. Input device 210 may be provided for the user to input information into computer system 200. Input device 210 may include a keyboard, a mouse, or other optical or wireless computer input device, etc. Further, input device 210 may include a control input device, such as a simulated steering wheel, or a brake pedal, etc. Network interface 212 may provide communication connections such that computer system 200 may be accessed remotely through computer networks via various communication protocols, such as transmission control protocol/internet protocol (TCP/IP), hyper text transfer protocol (HTTP), etc.

Database 214 may contain any data and/or any information related to racing parameter tuning applications. Database 214 may include any type of commercial or customized database. Database 214 may also include analysis tools for analyzing the information in the database. Processor 202 may also use database 214 to determine and store model data used to establish racing process model 104.

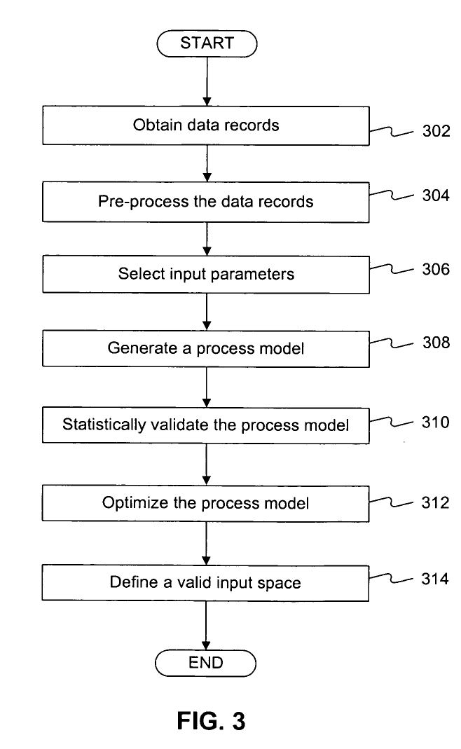

Processor 202 may perform a racing process model generation and optimization process to generate and optimize racing process model 104. FIG. 3 shows an exemplary model generation and optimization process performed by processor 202. As shown in FIG. 3, at the beginning of the generation and optimization process, processor 202 may obtain data records associated with input parameters 102 and output parameters 106 (step 302).

The data records may include information characterizing specific race cars, race tracks, drivers, and races involving individual race cars on individual racing tracks. For example, the data records may include physical characteristics of a race car, such as information on size, shape, weight, dimensions, configurations, engines, transmission, tires, etc., of the race car.

The data records may also include setup parameters of the race car. Setup parameters, as used herein, may refer to those parameters associated with configurations and operations of the race car and may be changed from time to time, either by a driver of the race car or by maintenance staff of the race car during a race or before the race. For example, setup parameters of the race car may include information on spoiler angle, wedge, front left tire pressure, rear left tire pressure, front right tire pressure, rear right tire pressure, front sway bar thickness, front toe, rear sway bar thickness, rear toe, etc., all of which may be changed or reconfigured. In certain embodiments, where an earthmoving machine is used, setup parameters may include tool angle, tool type, tool linkage, front left tire pressure, rear left tire pressure, front right tire pressure, rear right tire pressure, hydraulic pressure, hydraulic flow, and gearbox ratio. A desired set of values of the setup parameters may correspond to desired performance of the race car in the race.

The setup parameters may include hard setup parameters and soft setup parameters. A hard setup parameter may refer to a configuration parameter of the race car that may require a substantial amount of time to change. For example, hard setup parameters may include sway bar thickness, camber, or caster, etc., of the race car. Because it may take a substantial amount of time to change a hard setup parameter, it may be difficult to change hard setup parameters during a real race. On the other hand, a soft setup parameter may refer to a configuration parameter of the race car that may require relatively less time to change. For example, soft setup parameters may include tire pressure, gearbox ratio, or spoiler angle, etc., of the race car. Because it may take a lesser amount of time, compared to hard setup parameters, to change a soft setup parameter, soft setup parameters may be changed during a race, e.g., during a pit stop.

The data records may also include information about physical or operational limitations, i.e., constraint parameters, of the race car. For example, the data records may include information on tire pressure or temperature, engine water temperature, engine oil temperature, etc., which may be limited by maximum allowable values of these constraint parameters. Such constraint parameters may limit the race car from a certain type of operation. For example, if the engine oil temperature reaches beyond the maximum engine oil temperature, the driver of the race car may be unable to accelerate the race car during the race. In certain embodiments, where an earthmoving machine is used, constraint parameters may include tire temperature, engine water temperature, engine oil temperature, transmission oil temperature, hydraulic oil temperature, axle oil temperature, frame stress, and frame damage level, etc. Other constraint parameters, however, may also be used.

Further, the data records may include information about conditions of a particular race car, the environment, the driver's particular technique and path around a track, or a particular race track on which the race car performs the race, which may be referred to as condition parameters of the race car. The conditions of the race car or the race track may be uncontrollable because a driver of the race car or maintenance staff cannot change these conditions, even though values of these parameters may vary from time to time or from different race cars or race tracks. For example, uncontrollable condition parameters may include information about condition parameters such as ambient temperature, fuel load of the race car, and/or track temperature of the particular race track, etc. Other characteristics of the particular race track, however, may also be used. In certain embodiments, where an earthmoving machine is used, condition parameters may include ambient pressure and earth friction, mass, and viscosity, etc.

The data records may also include information about results of races performed by the race car on the particular race track, or results of races performed by a simulated race car on a simulated race track. For example, data records may include information on individual lap time, average lap time, and/or lap time variance, etc. In certain embodiments, where an earthmoving machine is used, results may include average task time and task time variance.

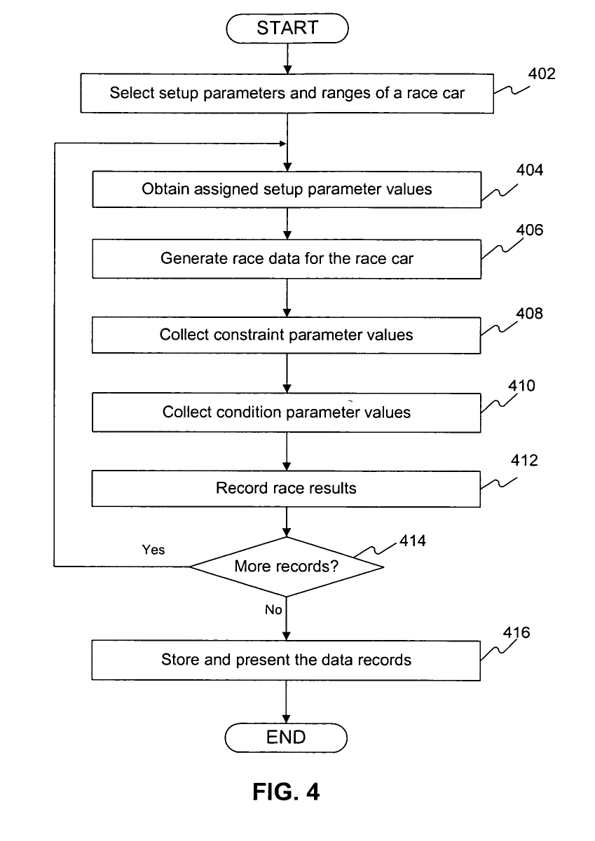

The data records may be collected in any appropriate way for collecting such data. For example, the data records may be collected from a test race car running on a real race track or may be collected from a race car in a real racing game. Further, the data records may also be obtained from another computer system having such data available. Alternatively, the data records may be generated artificially by other related processes, such as racing game computer programs. In one embodiment, the data records may be collected from data generation module 110. FIG. 4 shows an exemplary data generation process performed by processor 202 based on data generation module 110.

As shown in FIG. 4, processor 202 may select setup parameters and ranges of a race car (step 402). Processor 202 may select setup parameters (e.g., hard setup parameters and soft setup parameters) and ranges based on inputs from a user of computer system 200. For example, the user may select setup parameters such as spoiler angle, wedge, front left tire pressure, rear left tire pressure, front right tire pressure, rear right tire pressure, front sway bar thickness, front toe, rear sway bar thickness, rear toe, etc. The user may also select respective ranges for the setup parameters within which the race car may be operating. Alternatively, processor 202 may select setup parameters based on predetermined setup parameter list if the user does not select the setup parameters and may select ranges based on stored or default data if the user does not set all or any of the parameter ranges. Processor 202 may also display the setup parameters and default values of the setup parameter within the ranges.

After the setup parameters are selected, processor 202 may obtain assigned values for the setup parameters (step 404). Processor 202 may obtain the respective values of the setup parameters based on inputs from the user. Processor 202 may also obtain the values from stored data or default values of the setup parameters if the user does not assign all or any of the setup parameter values. In one embodiment, processor 202 may generate random values for the setup parameters within the ranges.

Further, after all setup parameters are selected and assigned, processor 202 may generate race data for the race car (step 406). Processor 202 may generate race data for the race car based on data generation module 110. In one embodiment, processor 202 may generate the race data by using a computer simulation of the race car and certain race tracks. For example, processor 202 may simulate the race car in a race, with or without the user's inputs of driving instructions, for a certain number of laps (e.g., 3, 4, 5, etc.) of the race track, and may generate simulated race results based on the setup parameters and certain race models included in data generation module 110. Data generation module 110 may generate the amount of time of each lap that the race car completes, and may also generate values of certain condition parameters of the race car after the race, such as values of tire temperature, engine water temperature, and/or engine oil, etc., the constraint parameters.

On the other hand, processor 202 may also generate the race data based on a physical race car configured according to the setup parameters. Drivers and/or maintenance staff may measure or collect data about the race car, the environment, and the race track during and after a practicing race or race exercise designed for collecting race data. The measured data may be inputted to data generation module 110 and may be further processed by processor 202 to generate the race data.

Processor 202 may also collect constraint parameter values (step 408). For example, processor 202 may collect or record values for tire temperature, engine water temperature, and engine oil temperature. These constraint parameter values may be collected after a simulated race, with a simulated race car or a physical race car, based on the particular race car with, for example, particular types of tires and engines. Other constraint parameters, however, may also be used.

Processor 202 may also collect condition parameter values (step 410). For example, processor 202 may collect or record values for ambient temperature, fuel load, and/or track temperature for a particular race track, etc. Because real-time values of condition parameters may be unavailable for race simulation, certain default values may be predetermined for such condition parameters based on certain conditions, such as time of the year, location of the race track, etc., or certain random values of the condition parameters may be chosen within certain ranges of these parameters.

Further, processor 202 may record data results (e.g., time information, tire temperature, engine water temperature, and/or engine oil temperature, etc.) and values of corresponding parameters (e.g., setup parameters, condition parameters, etc.) in a data record (step 412). Processor 202 may also derive certain performance parameters, such as average lap time for all laps in the race, and lap time variance of the race, etc., to be included in the data record generated.

Processor 202 may determine whether more data records need to be created (step 414). If processor 202 determines that more data records need to be created (step 414; yes), processor 202 may continue the data generation process in step 404. On the other hand, if processor 202 determines that no more data records need to be created (step 414; no), processor 202 may store and present the data records (step 416). Processor 202 may store the data records in storage 216 and/or in database 214. Processor 202 may also present the data records to the user or to other computer programs or systems such that the data records may be further used or analyzed.

Returning to FIG. 3, after the data records are obtained (step 302), the data records may be used to build racing process model 104 and to validate racing process model 104. For example, setup parameters (e.g., spoiler angle, wedge, front left tire pressure, rear left tire pressure, front right tire pressure, rear right tire pressure, front sway bar thickness, front toe, rear sway bar thickness, rear toe, etc.) and condition parameters (e.g., ambient temperature and track temperature, etc.) may be included in input parameters 102; and constraint parameters (e.g., tire temperature, engine water temperature, and/or engine oil, etc.) and performance parameters (e.g., average lap time and lap time variance, etc.) may be included in output parameters 106 to establish racing process model 104. In addition, the data records may also be used to observe and optimize racing process model 104.

Further, processor 202 may pre-process the data records to clean up the data records for obvious errors and to eliminate redundancies (step 304). Processor 202 may remove approximately identical data records and/or remove data records that are out of a reasonable range in order to be meaningful for model generation and optimization. After the data records have been pre-processed, processor 202 may select proper input parameters 102 by analyzing the data records (step 306).

The data records may be associated with many input variables, such as variables corresponding to various physical characteristics of the race car and the race track, such as shape, weight, engine parameters, setup parameters, condition parameters, race track configurations, etc. The number of input variables may be greater than the number of input parameters 102 (e.g., spoiler angle, wedge, front left tire pressure, rear left tire pressure, front right tire pressure, rear right tire pressure, front sway bar thickness, front toe, rear sway bar thickness, rear toe, ambient temperature, and track temperature, etc.) used for racing process model 104, that is, input parameters 102 may be a subset of the input variables.

In certain situations, the number of input variables in the data records may exceed the number of the data records and lead to sparse data scenarios. The number of the input variables may need to be reduced to, for example, the number of variables in a most relevant subset in order to create mathematical models within practical computational time limits.

Processor 202 may select input parameters 102 according to predetermined criteria. For example, processor 202 may choose input parameters 102 by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 using any appropriate method. For example, the normal data set may include characteristic data associated with input parameters 102 that produce desired output parameters. On the other hand, the abnormal data set may include any characteristic data that may be out of tolerance or may need to be avoided. The normal data set and abnormal data set may be predefined by processor 202. In a race environment, normal data set may indicate a preferred or desired setup for potentially winning the race, while abnormal data may indicate an undesired setup for potentially losing the race.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as

MDᵢ=(Xᵢ−μₓ)Σ⁻¹(Xᵢ−μₓ)′ (1)

where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select a desired subset of input parameters such that the mahalanobis distance between the normal data set and the abnormal data set is maximized or optimized. A genetic algorithm may be used by processor 202 to search input parameters 102 for the desired subset with the purpose of maximizing the mahalanobis distance. Processor 202 may select a candidate subset of input parameters 102 based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables 102 if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 102) is selected.

After selecting input parameters 102 (e.g., spoiler angle, wedge, front left tire pressure, rear left tire pressure, front right tire pressure, rear right tire pressure, front sway bar thickness, front toe, rear sway bar thickness, rear toe, ambient temperature, and track temperature, etc.), processor 202 may generate racing process model 104 to build interrelationships between input parameters 102 and output parameters 106 (step 308). In certain embodiments, racing process model 104 may correspond to a computational model, such as, for example, a computational model built on any appropriate type of neural network. The type of neural network computational model that may be used may include back propagation, feed forward models, cascaded neural networks, and/or hybrid neural networks, etc. Particular type or structures of the neural network used may depend on particular applications. Other types of computational models, such as linear system or non-linear system models, etc., may also be used.

The neural network computational model (i.e., racing process model 104) may be trained by using selected data records. For example, the neural network computational model may include a relationship between output parameters 106 (e.g., average lap time, lap time variance, tire temperature, engine water temperature, and/or engine oil, etc.) And input parameters 102 (e.g., spoiler angle, wedge, front left tire pressure, rear left tire pressure, front right tire pressure, rear right tire pressure, front sway bar thickness, front toe, rear sway bar thickness, rear toe, ambient temperature, and track temperature, etc.). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 310). Statistical validation may refer to an analyzing process to compare outputs of the neural network computational model with actual or expected outputs to determine the accuracy of the computational model. Part of the data records may be reserved for use in the validation process.

Alternatively, processor 202 may also generate simulation or validation data for use in the validation process. This may be performed either independently of a validation sample or in conjunction with the sample. Statistical distributions of inputs may be determined from the data records used for modeling. A statistical simulation, such as Latin Hyper cube simulation, may be used to generate hypothetical input data records. These input data records are processed by the computational model, resulting in one or more distributions of output characteristics. The distributions of the output characteristics from the computational model may be compared to distributions of output characteristics observed in a population. Statistical quality tests may be performed on the output distributions of the computational model and the observed output distributions to ensure model integrity.

Once trained and validated, racing process model 104 may be used to predict values of output parameters 106 when provided with values of input parameters 102. Further, processor 202 may optimize racing process model 104 by determining desired distributions of input parameters 102 based on relationships between input parameters 102 and desired distributions of output parameters 106 (step 312).

Processor 202 may analyze the relationships between desired distributions of input parameters 102 and desired distributions of output parameters 106 based on particular applications. For example, processor 202 may select desired ranges for output parameters 106 (e.g., average lap time, lap time variance, tire temperature, engine water temperature, and/or engine oil, etc.). Processor 202 may then run a simulation of the computational model to find a desired statistical distribution for an individual input parameter (e.g., spoiler angle, wedge, front left tire pressure, rear left tire pressure, front right tire pressure, rear right tire pressure, front sway bar thickness, front toe, rear sway bar thickness, rear toe, ambient temperature, and track temperature, etc.). That is, processor 202 may separately determine a distribution (e.g., mean, standard variation, etc.) Of the individual input parameter corresponding to the normal ranges of output parameters 106. After determining respective distributions for all individual input parameters, processor 202 may combine the desired distributions for all the individual input parameters to determine desired distributions and characteristics for overall input parameters 102.

Alternatively, processor 202 may identify desired distributions of input parameters 102 simultaneously to maximize the possibility of obtaining desired outcomes. In certain embodiments, processor 202 may simultaneously determine desired distributions of input parameters 102 based on the zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$

where x̅ᵢ represents the mean or expected value of an ith input; x̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, x̅ᵢ may be less than or equal to zero. A value of 3σᵢ may be added to x̅ᵢ to correct such problematic condition. If, however, x̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models.

Under certain other circumstances, σⱼ may be equal to zero. Processor 202 may then determine that the model under optimization may be insufficient to reflect output parameters within a certain range of uncertainty. Processor 202 may assign an indefinite large number to ζ. Further, certain constraint parameters (e.g., maximum tire temperature, maximum engine water temperature, and/or maximum engine oil temperature, etc.) may also limit the values of σⱼ.

Processor 202 may identify a desired distribution of input parameters 102 such that the zeta statistic of the neural network computational model (i.e., racing process model 104) is maximized or optimized. Any appropriate type of genetic algorithm may be used by processor 202 to search the desired distribution of input parameters with the purpose of maximizing the zeta statistic. Processor 202 may select a candidate set of values of input parameters 102 with predetermined search ranges and run a simulation of racing process model 104 to calculate the zeta statistic parameters based on input parameters 102, output parameters 106, and the neural network computational model. Processor 202 may obtain x̅ᵢ and σᵢ by analyzing the candidate set of values of input parameters 102, and obtain x̅ⱼ and σⱼ by analyzing the outcomes of the simulation. Further, processor 202 may obtain |Sᵢⱼ| from the trained neural network as an indication of the impact of the ith input on the jth outcome.

Processor 202 may select the candidate set of values of input parameters if the genetic algorithm converges (i.e., the genetic algorithm finds the maximized or optimized zeta statistic of racing process model 104 corresponding to the candidate set of input parameters). If the genetic algorithm does not converge, a different candidate set of values of input parameters 102 may be created by the genetic algorithm for further searching. This searching process may continue until the genetic algorithm converges and a desired set of values of input parameters 102 is identified. Processor 202 may further determine desired distributions (e.g., mean and standard deviations) of input parameters 102 based on the desired input parameter value set. Once the desired distributions are determined, processor 202 may define a valid input space that may include any input parameter within the desired distributions (step 314).

In one embodiment, statistical distributions of certain input parameters (e.g., condition parameters) may be impossible or impractical to control. For example, an input parameter may be associated with a physical or environmental attribute of a race car or a race track, such as ambient temperature, and track temperature, etc., or the input parameter may be associated with a constant variable within racing process model 104 itself. These input parameters may be used in the zeta statistic calculations to search or identify desired distributions for other input parameters corresponding to constant values and/or statistical distributions of these input parameters. Further, both hard setup parameters and soft setup parameters may be optimized for determining the desired distributions such that enough time would be allowed to configure the setup parameters to produce desired output parameters 106. However, when insufficient time is available to change or reconfigure a hard setup parameter, such hard setup parameter may be treated as a constant variable.

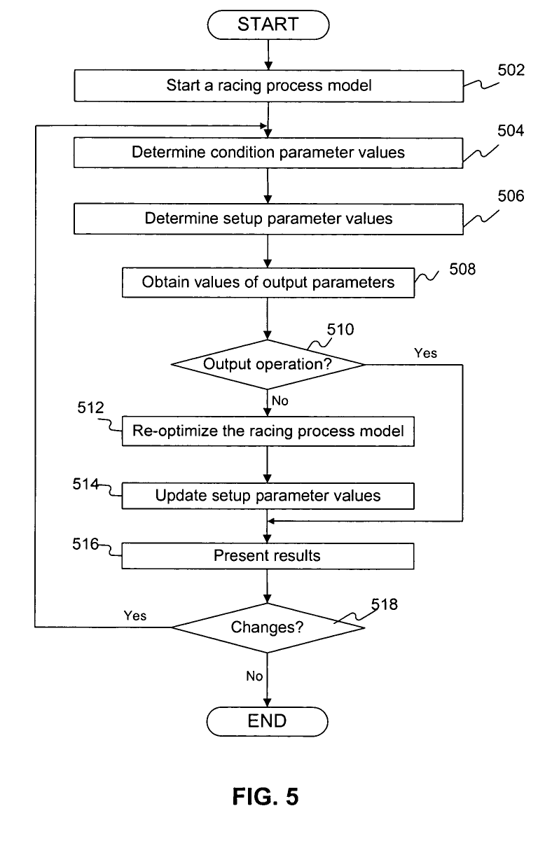

After racing process model 104 is trained, validated, and optimized, a user may use racing process model to perform various operations. For example, racing process model 104 may be used to predict race results based on certain values of condition parameters and setup parameters, or may be used to create desired race car setup parameter to win a particular race. These operations may be performed either before or during the race. FIG. 5 shows an exemplary model operation process performed by processor 202.

As shown in FIG. 5, at the beginning of the model operation process, processor 202 may start a racing process model 104 (step 502). If racing process model 104 has not been established, processor 202 may also establish process model 104 as described above. Processor 202 may determine condition parameter values (step 504). The user may input the values of condition parameters (e.g., ambient temperature, fuel load, and track temperature, etc.) when such values are available before or during the race. For example, the available values of condition parameters may include recorded or collected condition parameter values, actual values of condition parameter values, and/or anticipated or estimated condition parameter values. Further, the user may cause processor 202 to perform this model operation process whenever such values may be changed or updated, such as during a pit stop of the race car.

Processor 202 may also determine setup parameter values (step 506). Processor 202 may determine initial values of setup parameters (e.g., spoiler angle, wedge, front left tire pressure, rear left tire pressure, front right tire pressure, rear right tire pressure, front sway bar thickness, front toe, rear sway bar thickness, and rear toe, etc.) based on a set of default values or based on the optimized values for input parameters 102 or based on inputs from the user. Alternatively, processor 202 may determine random values for the setup parameters within the input space based on predetermined criteria. Further, as explained above, setup parameters may include both hard setup parameters and soft setup parameters, processor 202 may determine setup parameter values with consideration on whether hard setup parameters and soft setup parameters are involved.

In certain embodiments, before a race, when recorded condition parameter values may be used, processor 202 may determine values for both hard setup parameter values and soft setup parameter values such that all setup parameters may be adjusted to derive desired output parameter values. In certain other embodiments, during the race, when actual condition parameter values may be used, processor 202 may only determine soft setup parameter values while leaving the values of hard setup parameters unchanged. Because it may take a substantial amount of time to change values of hard setup parameters, only soft setup parameters may be adjusted to derive desired output parameter values. Further, during the race, processor 202 may also determine soft setup parameter values with anticipated condition parameter values such that those values of soft setup parameters deriving desired output parameter values may be provided to the user to adjust the soft setup parameter during the race in anticipation of changes in values of condition parameters.

Processor 202 may obtain values of output parameters (e.g., constraint parameters and performance parameters, etc.) (step 508). In certain embodiment, processor 202 may perform an output operation to obtain values of constraint parameters and performance parameters based on process model 104 and values of input parameters 102 (e.g., condition parameters and setup parameters, etc.). Output operation may refer to a “what-if” analysis operation by providing a set of values of input parameters 102 to process model 104 to predict corresponding values of output parameters 106, and to determine desired values of some or all of input parameters 102. For example, before a race, processor 202 may predict values of performance parameters and constraint parameters corresponding to values of hard and soft setup parameters and recorded condition parameters to determine those hard setup parameters and soft setup parameters corresponding to desired performance parameter values (e.g., minimum lap time, etc.) with permissive constraint parameter values.

Further, during the race, processor 202 may predict values of performance parameters and constraint parameters corresponding to values of soft setup parameters and actual condition parameters to determine the soft setup parameters corresponding to desired performance parameter values (e.g., minimum lap time, etc.) with permissive constraint parameter values. Processor 202 may also predict values of performance parameters and constraint parameters corresponding to values of soft setup parameters and anticipated condition parameters to determine the soft setup parameters corresponding to desired performance parameter values (e.g., minimum lap time, etc.) with permissive constraint parameter values.

On the other hand, processor 202 may also perform an input operation to generate desired setup parameter values based on desired performance parameter values or output parameter values. For the input operation, processor 202 may obtain values of performance parameters or output parameter based on user input or from storage 216. Processor 202 may also obtain maximum values of constraint parameters (e.g., maximum tire temperature, maximum engine water temperature, and/or maximum engine oil temperature, etc.) based on inputs from the user, or based on predetermined constraint parameter values for a particular race car. Such maximum values may be used to limit certain input parameter values and/or input space of racing process model 104. Any values of constraint parameters within the maximum values may be referred to as permissive constraint parameter values. If processor 202 determines that racing process model 104 produces values of the constraint parameters exceeding any of maximum tire temperature, maximum engine water temperature, and maximum engine oil temperature, processor 202 may discard such results.

After obtaining output parameter values (step 508), processor 202 may determine further actions based on the type of operation in step 508 (step 510). If processor 202 determines that the type of operation is output operation (step 510; yes), processor 202 may continue the model operation process from step 516. Processor 202 may present results of the model operation process, such as values of output parameters and/or input parameters, etc. (step 514). For example, processor 202 may display values of setup parameters, condition parameters, constraint parameters, and/or performance parameters through a user graphic interface (GUI) on console 208. Processor 202 may also present the results to other computer programs or systems such that further analysis of the results may be achieved.

On the other hand, if processor 202 determines that the type of operation is input operation (step 510; no), processor 202 may continue the model operation process from step 512. Processor 202 may re-simulate or re-optimize racing process model 104 based on the determined values of the condition parameters, values of the setup parameters, and constraint parameter values (step 512). For example, processor 202 may re-optimize racing process model 104 or re-optimizing the values and statistical distributions of input parameters and output parameters based on the zeta statistics as explained above with respect to FIG. 3. As explained above, certain input parameters with non-changeable values may be used in the zeta statistic calculations to search or identify desired distributions for other input parameters corresponding to constant values and/or statistical distributions of these input parameters. Because hard setup parameters may take a substantial amount of time to change, processor 202 may treat hard setup parameters as parameters with constant values and may determine desired values for soft setup parameters during normal operations during a race. Under certain circumstances, however, hard setup parameters may also be re-optimized.

After re-optimizing racing process model 104 (step 510), an updated input space may be created. Processor 202 may update setup parameter values based upon the updated input space (step 512). Processor 202 may determine a set of setup parameter values corresponding to a minimum average lap time and/or a minimum lap time variance as a desired set of parameters for the race. Processor 202 may also determine a plurality sets of setup parameter values corresponding to performance parameter values such as desired average lap time and/or lap time variance. The user may choose a desired set of setup parameter values from the plurality of sets of setup parameter values.

Processor 202 may also present results of the parameter setup process (step 514). For example, processor 202 may display values of setup parameters, condition parameters, constraint parameters, and/or performance parameters through a user graphic interface (GUI) on console 208. Processor 202 may also present the results to other computer programs or systems such that further analysis of the results may be achieved.

Further, processor 202 may determine whether more “what-if” analysis operations are to be performed or whether any changes of condition parameters and/or setup parameters are needed (step 518). If processor 202 determines that more “what-if” analysis operations are to be performed or that changes to these parameters are needed (step 518; yes), processor 202 may continue the model operation process in step 508. On the other hand, if processor 202 determines that more “what-if” analysis operations need not to be performed and that changes to these parameters are not needed (step 518; no), processor 202 may complete the parameter setup process.

### INDUSTRIAL APPLICABILITY

The disclosed methods and systems may provide fast and effective solutions to model behavior of race cars to identify optimal setup which minimizes qualifying lap time without exceeding operating limitations. The optimal setup may be first established based on different types of computer simulation of races, with default values for unavailable real-time variables. The established optimal setup may be further tuned after the values of real-time variables are available such that the real-time adjustment to the racing environment and race car conditions can be achieved.

The disclosed methods and systems may simultaneously derive optimal values for many different input parameters because the input parameters practically are often interconnected in certain ways. By deriving an overall interrelationship between performance and the input parameters, the modeling and re-modeling of race car behaviors can be computationally practical and may be performed in real-time.

The disclosed methods and systems may also be used in other fields concerning games, in addition to vehicles, and may provide optimal setup or configuration processes for obtaining desired game results. For example, such methods and systems may provide effective solutions to be used in many sports, such as boating racing, aircraft racing, winter sports, water sports, track and field, etc., to adjust parameters or configuration of the sports equipment in order to achieve optimal results.

Further, the disclosed methods and systems may also be used in combination of other simulation software programs to provide an integrated solution for simulating races. For example, developers and manufacturers of computer simulation programs may use the disclosed methods and systems for providing analysis tools to add values to their computer simulation programs and to users.

Other embodiments, features, aspects, and principles of the disclosed exemplary systems will be apparent to those skilled in the art and may be implemented in various environments and systems.

What is claimed is:

1. A method for setting up setup parameters for a machine to perform a time-constraint task over a fixed course, comprising:
establishing a process model indicative of interrelationships between performance parameters of the machine and a plurality of setup parameters of the machine based on data records generated by a computer system, wherein the performance parameters are associated with constraint parameters of the machine and the setup parameters are associated with condition parameters of the fixed course;
obtaining values of the condition parameters;
adjusting the process model to generate a desired set of values of the setup parameters corresponding to a desired set of values of the performance parameters of the race car based on the values of condition parameters; and
presenting the desired set of values setup parameters.

2. The method according to claim 1, wherein:
the machine is a race car;
the time-constrained task is a race; and
the fixed course is a race track.

3. The method according to claim 1, wherein:
the machine is an earthmoving machine;
the time-constrained task is an earthmoving task; and
the fixed course is a spatially-constrained work site.

4. The method according to claim 1, wherein the data records are generated by:
selecting the setup parameters with corresponding ranges;
obtaining respective values of the setup parameters within the corresponding ranges;
producing respective values of the performance parameters from the values of setup parameters based on one of a computer simulation of the machine configured with the values of setup parameters and a time-constraint task performed by the machine;
collecting respective values of the constraint parameters; and
collecting respective values of the condition parameters.

5. The method according claim 4, further including:
creating the data records including the values of the performance parameters, the constraint parameters, the setup parameters, and the condition parameters; and
presenting the data records.

6. The method according to claim 1, wherein the establishing includes:
selecting the plurality of input parameters including the setup parameters and the condition parameters from the data records;
generating a computational model indicative of the interrelationships between the input parameters and a plurality of output parameters including the performance parameters and the constraint parameters;
determining desired statistical distributions of the plurality of input parameters of the computational model; and
recalibrating the setup parameters based on the desired statistical distributions.

7. The method according to claim 6, wherein selecting further includes:
pre-processing the data records; and
using a genetic algorithm to select the plurality of input parameters from input variables of the data records based on a mahalanobis distance between a normal data set and an abnormal data set of the data records.

8. The method according to claim 6, wherein generating further includes:
creating a neural network computational model;
training the neural network computational model using the data records; and
validating the neural network computation model using the data records.

9. The method according to claim 6, wherein determining further includes:
determining a candidate set of values of the input parameters with a maximum zeta statistic using a genetic algorithm; and
determining the desired distributions of the input parameters based on the candidate set of values,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

10. The method according to claim 1, wherein the setup parameters include one or more of spoiler angle, wedge, front left tire pressure, rear left tire pressure, front right tire pressure, rear right tire pressure, front sway bar thickness, front toe, rear sway bar thickness, gearbox ratio and rear toe.

11. The method according to claim 1, wherein the setup parameters include one or more of tool angle, tool type, tool linkage, front left tire pressure, rear left tire pressure, front right tire pressure, rear right tire pressure, hydraulic pressure, hydraulic flow, and gearbox ratio.

12. The method according to claim 1, wherein the condition parameters include ambient temperature and track temperature.

13. The method according to claim 1, wherein the condition parameters include ambient pressure and earth friction, mass and viscosity.

14. The method according to claim 1, wherein the performance parameters include average lap time and lap time variance.

15. The method according to claim 1, wherein the performance parameters include average task time and task time variance.

16. The method according to claim 1, wherein the constraint parameters include tire temperature, engine water temperature, and engine oil temperature.

17. The method according to claim 1, wherein the constraint parameters include one or more of tire temperatures, the engine water temperature, engine oil temperature, transmission oil temperature, hydraulic oil temperature, axle oil temperature, frame stress, and frame damage level.

18. A method for setting up setup parameters for a machine to perform a time-constraint task over a fixed course, comprising:
starting a process model indicative of interrelationships between performance parameters of the machine and a plurality of setup parameters of the machine based on data records generated by a computer system, wherein the performance parameters are associated with constraint parameters of the machine and the setup parameters are associated with condition parameters of the fixed course;
obtaining values of the condition parameters and the setup parameters, wherein the setup parameter includes hard setup parameters and soft setup parameters;
generating values of the performance parameters and the constraint parameters based on the process model and the values of the condition parameters and the setup parameters;
determining desired values of the setup parameters corresponding to desired values of the performance parameters with permissive values of the constraint parameters; and
presenting the desired set of values setup parameters.

19. The method according to claim 18, wherein the values of the condition parameters include recorded values of the condition parameters and the desired values of the setup parameters include desired values of both hard setup parameters and soft setup parameters.

20. The method according to claim 18, wherein the values of the condition parameters include actual values of the condition parameters and the desired values of the setup parameters include desired values of only soft setup parameters.

21. The method according to claim 18, wherein the values of the condition parameters include anticipated values of the condition parameters and the desired values of the setup parameters include desired values of only soft setup parameters.

22. A computer system, comprising:
a database containing data records associating a plurality of setup parameters and a plurality of performance parameters corresponding to a machine performing a time-constraint task on a fixed course; and
a processor configured to:
establish a process model indicative of interrelationships between performance parameters of the machine and a plurality of setup parameters of the machine based on data records generated by a computer system, wherein the performance parameters are associated with constraint parameters of the machine and the setup parameters are associated with condition parameters of the fixed course;
obtain values of the condition parameters;
adjust the process model to generate a desired set of values of the setup parameters corresponding to a desired set of values of the performance parameters of the race car based on the values of condition parameters; and
present the desired set of values setup parameters.

23. The computer system according to claim 22, wherein:
the machine is a race car;
the time-constrained task is a race; and
the fixed course is a race track.

24. The computer system according to claim 22, wherein:
the machine is an earthmoving machine;
the time-constrained task is an earthmoving task; and
the fixed course is a spatially-constrained work site.
